(19) United States
(12) Patent Application Publication
(10) Pub. No.: US 2010/0050361 A1
(43) Pub. Date: Mar. 4, 2010

(54) Windshield wiper connector

(76) Inventors: Chuan-Chih Chang, Banqiao City (TW); Chih-Ming Yang, Banqiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,186

(22) Filed: Aug. 26, 2008

(51) Int. Cl. B60S 1/40

(52) U.S. Cl. 15/250.32

(57) ABSTRACT

A windshield wiper connecting device for connecting a windshield wiper to a wiper driving arm includes: a first connecting element having a bottom plate, a plurality of first buckling pieces and two abutting portions, the first buckling pieces being bent and fixedly buckled to the windshield wiper; a second connecting element having a semi-cylindrical shaft base, two locking portions, four wings and four hooks, the hooks being locked and connected to the side walls of the abutting portions; and a mask covering the outside of the first connecting element and the second connecting element, the mask being connected to the wiper driving arm, wherein the shaft base of the second connecting element is provided on the bottom plate of the first connecting element, the shaft base of the second connecting element and the wings of the second connecting elements abut the abutting portions of the first connecting element.

### BACKGROUND OF THE INVENTION

1. Field of the Invention

The present invention relates to a windshield wiper connector, and in particular to a windshield wiper connector that can be used to drive different models of windshield wiper arms.

2. Description of Related Art

Windshield wipers are mounted on the front and rear windshields of a car to wipe off rain or dirt adhering ton the windshield. In this way, the vision of a driver will not be impaired by rain or dirt and thus danger can be more easily avoided.

The conventional windshield wiper includes a wiper arm, a connector and a wiper blade. The connector is fixed at the middle portion of the wiper blade at the side facing away from the windshield. The wiper blade can be mounted on the wiper arm via the connector, so that the wiper arm can drive the windshield wiper blades, thereby wiping off rain or dirt adhering on the windshield.

However, the conventional wiper connector can be only used in a small range. More specifically, it can be only used to the wiper arms of the same kind of car, but cannot be used to the wiper arms of different kinds of cars. Since the components of the conventional windshield wipers are not sufficiently standardized, it is necessary to manufacture special components for different kinds of cars by corresponding molds, which increases manufacturing costs.

Consequently, because of the above limitation present in the technical design of the prior art, the inventor strives via real world experience and academic research to develop the present invention, which can effectively improve the limitations described above.

### SUMMARY OF THE INVENTION

The object of the present invention is to provide a windshield wiper connector, wherein its components are universal and thus can be applied to the wiper arms of different kinds of cars, thereby reducing manufacturing costs.

In order to achieve the above objects, the present invention provides a windshield wiper connector for connecting a windshield wiper blade to a wiper arm. The windshield wiper connector includes a first connecting element having a bottom plate, a plurality of first clips and two abutting portions, the first clips being bent and fixedly clipped to the windshield wiper blade; a second connecting element having a semi-cylindrical shaft base, two locking portions, four wings and four hooks, the hooks being locked and connected to the side walls of the abutting portions; and a mask covering the outside of the first connecting element and the second connecting element, the mask being connected to the wiper arm, wherein the shaft base of the second connecting element is provided on the bottom plate of the first connecting element, the locking portions of the second connecting element are connected to the abutting portions of the first connecting element, and the shaft base of the second connecting element and the wings of the second connecting elements abut the abutting portions of the first connecting element.

The present invention has advantageous features as follows. The windshield wiper connector of the present invention has a first connecting element and a second connecting element that can be applied to the wiper arms of different kinds of cars. Therefore, the user only needs to change the mask according to different wiper arms. The first connecting element and the second connecting element are universal components, so that it is unnecessary to use different molds to manufacture them. Therefore, the manufacturing cost can be reduced.

In order to further understand the characteristics and technical contents of the present invention, a detailed description relating thereto will be made with reference to the accompanying drawings. However, the drawings are illustrative only, but not used to limit the scope of the present invention.

### BRIEF DESCRIPTION OF THE DRAWINGS

FIG. 1 is an exploded perspective view showing the windshield wiper connector in accordance with the first embodiment of the present invention;

FIG. 1A is a partially assembled perspective view showing the windshield wiper connector in accordance with the first embodiment of the present invention;

FIG. 1B is a perspective view showing a portion of elements of the windshield wiper connector in accordance with the first embodiment of the present invention;

FIG. 2 is an assembled perspective view showing the windshield wiper connector in accordance with the first embodiment of the present invention;

FIG. 3 is an exploded perspective view showing the windshield wiper connector in accordance with the second embodiment of the present invention;

FIG. 4 is an assembled perspective view showing the windshield wiper connector in accordance with the second embodiment of the present invention;

FIG. 5 is an exploded perspective view showing the windshield wiper connector in accordance with the third embodiment of the present invention;

FIG. 6 is an assembled perspective view showing the windshield wiper connector in accordance with the third embodiment of the present invention;

FIG. 7 is an exploded perspective view showing the windshield wiper connector in accordance with the fourth embodiment of the present invention;

FIG. 8 is an assembled perspective view showing the windshield wiper connector in accordance with the fourth embodiment of the present invention;

FIG. 9 is an exploded perspective view showing the windshield wiper connector in accordance with the fifth embodiment of the present invention; and

FIG. 10 is an assembled perspective view showing the windshield wiper connector in accordance with the fifth embodiment of the present invention.

### DETAILED DESCRIPTION OF THE PREFERRED EMBODIMENTS

In order to further understand the characteristics and technical contents of the present invention, a detailed description relating thereto will be made with reference to the accompanying drawings.

### First Embodiment

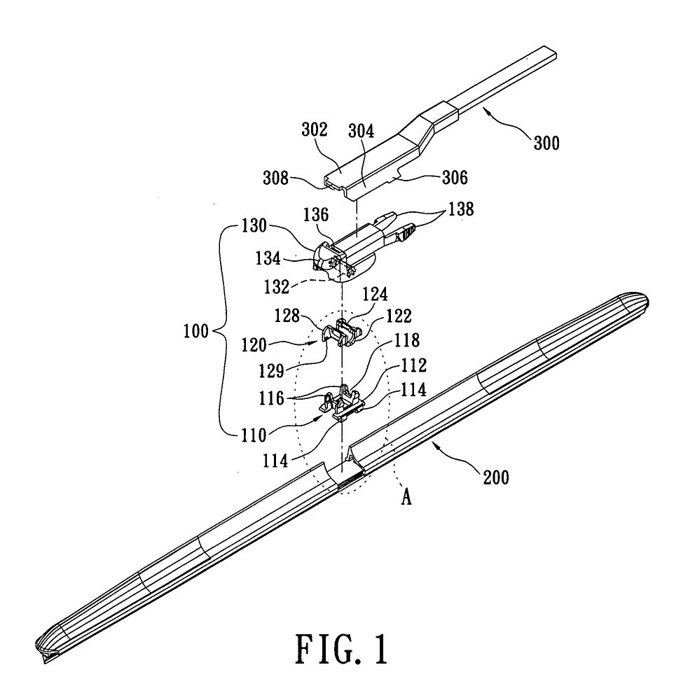

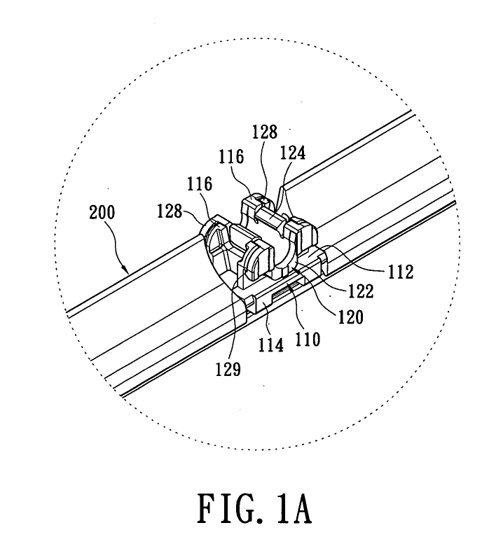

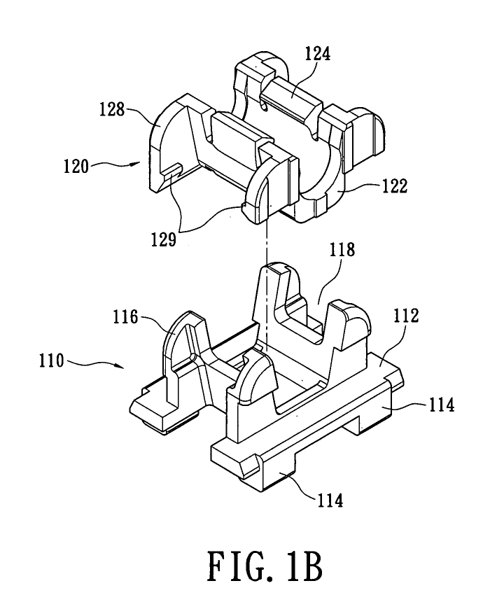

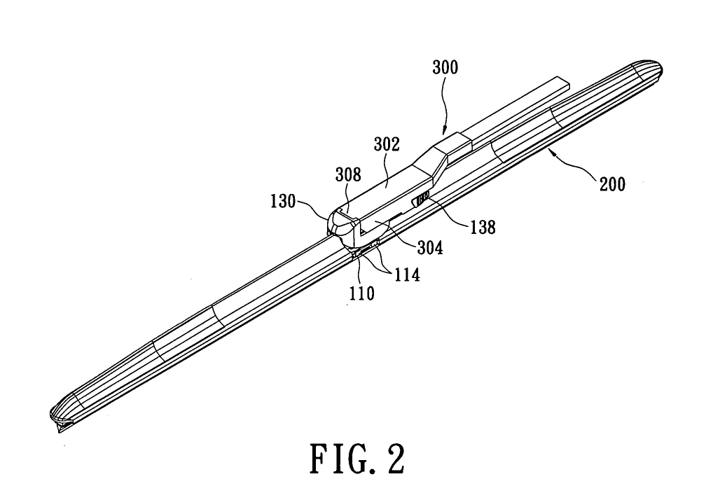

Please refer to FIGS. 1, 1A, 1B and 2. The first embodiment of the present invention provides a windshield wiper connector 100 for connecting a windshield wiper blade 200 to a wiper arm 300. The windshield wiper connector 100 includes a first connecting element 110 connected to the windshield wiper blade 200; a second connecting element 120 connected to the wiper arm 300; and a mask 130 for covering the outside of the first connecting element 110 and the second connecting element 120.

The first connecting element 110 has a bottom plate 112, four first clips 114 and two abutting portions 116. In the present embodiment, the first clips 114 are plates extending from both sides of the bottom plate 112. The first clips 114 are bent and fixedly clipped to the middle portion of the top surface of the windshield wiper blade 200. The abutting portions 116 are U-shaped plates formed from the top surface of the bottom plate 112. Each of the side walls of the abutting portions 116 is provided with a through hole 118.

The second connecting element 120 has a semi-cylindrical shaft base 122, two locking portions 124, four wings 128 and four hooks 129. In the present embodiment, the locking portions 124 are formed into rectangular troughs from both sides of the inner walls of the shaft base 122. The wings 128 are plates extending from both ends of the shaft base 122. The hooks 129 are protrusions of the wall surfaces of the wings 128. The hooks 129 are clipped and connected to the side walls of the abutting portions 116. The shaft base 122 of the second connecting element 120 is disposed on the bottom plate 112 of the first connecting element 110. The locking portions 124 of the shaft base 122 are inserted into the through holes 118 of the abutting portions 116. The shaft base 122, the wings 128 of the second connecting element 120 abut the abutting portions 116 of the first connecting element 110.

The mask 130 is an open casing that covers the outside of the first connecting element 110 and the second connecting element 120. The mask 130 is connected to the wiper arm 300. More specifically, the mask 130 includes a shaft 132, a protrusion 134 formed from the front end of the mask 130, a trough 136 provided on a rear edge of the protrusion 134, and two clipping arms 138 extending from both sides of the rear end of the mask 130. The shaft 132 is disposed on the shaft base 122 of the second connecting element 120. The shaft 132 is fixed to locking portions 124 of the shaft base 122 of the second connecting element 120. In the present embodiment, the wiper arm 300 has a head 302. Both sides of the head 302 extend downwards to form a flange 304 respectively. The lower edge of the flange 304 is provided with a locking piece 306. The front end of the head 304 is provided with a boss 308. The wiper arm 300 is provided on the mask 130. The front end of the head 302 abuts the protrusion 134. The boss 308 on the front end of the head 302 is locked in the trough 136 of the mask 130. The two locking pieces 306 of the wiper arm 300 are locked with the two clipping arms 138 of the mask 130, so that the wiper arm 300 can be connected to the windshield wiper blade 200 via the windshield wiper connector 100.

### Second Embodiment

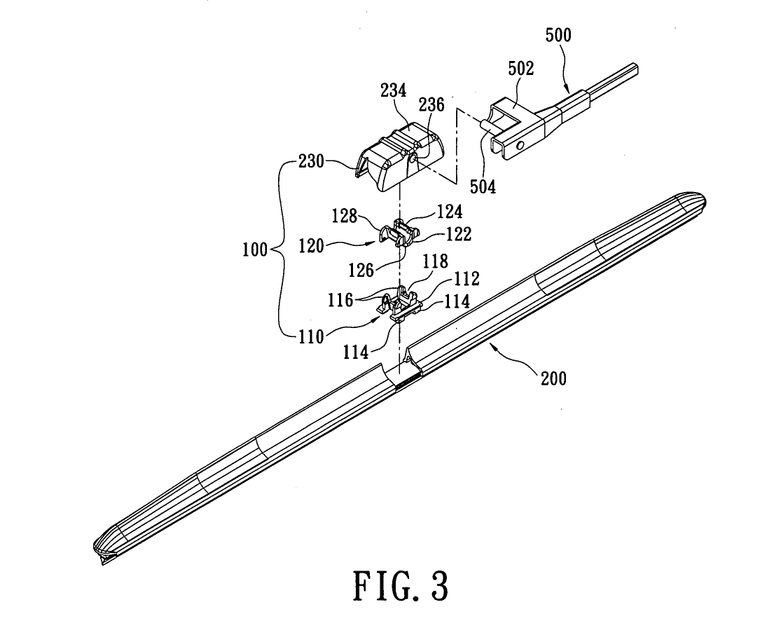

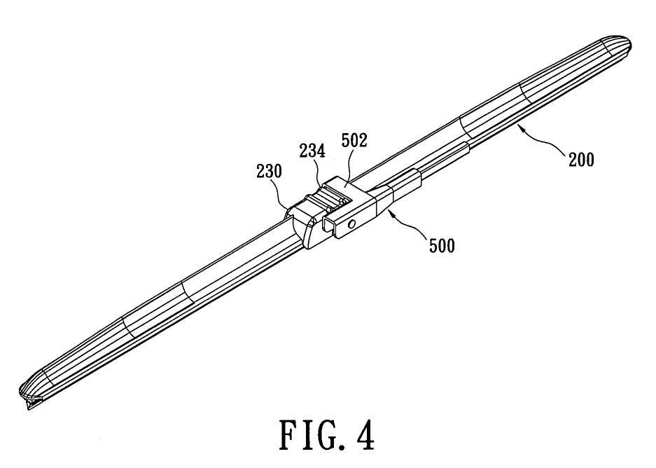

Please refer to FIGS. 3 and 4, which show the second embodiment of the present invention. The mask 230 includes a traversing portion 234 formed at the top surface of the mask 230, and an insertion hole 236 formed inwards and vertically in the side surface of the mask 230. In the present embodiment, the front end of the wiper arm 500 has a traversing piece 502 and a pin 504. The traversing piece 502 traverses the traversing portion 234 of the mask 130. The pin 504 is inserted into the insertion hole 236 of the mask 130 and the shaft base 122 of the second connecting element 120 with the locking portions 124 being fixed to the pin 504. In this way, the wiper arm 500 can be connected to the windshield wiper blade 200 via the windshield wiper connector 100.

### Third Embodiment

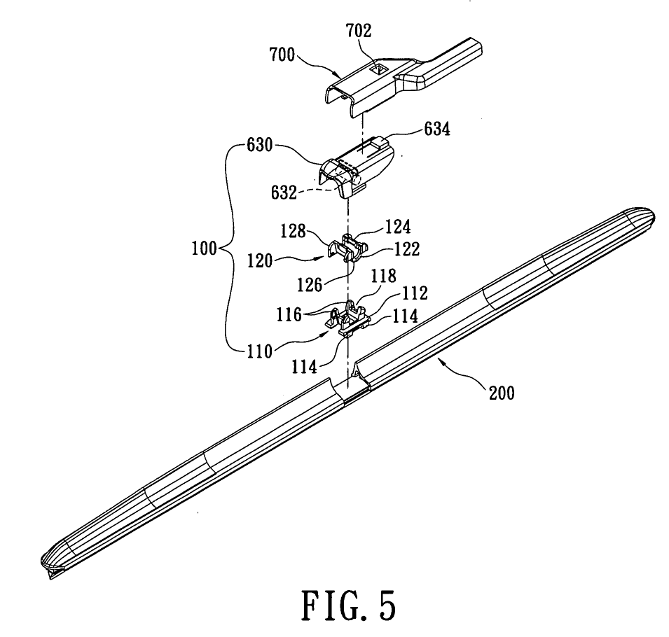

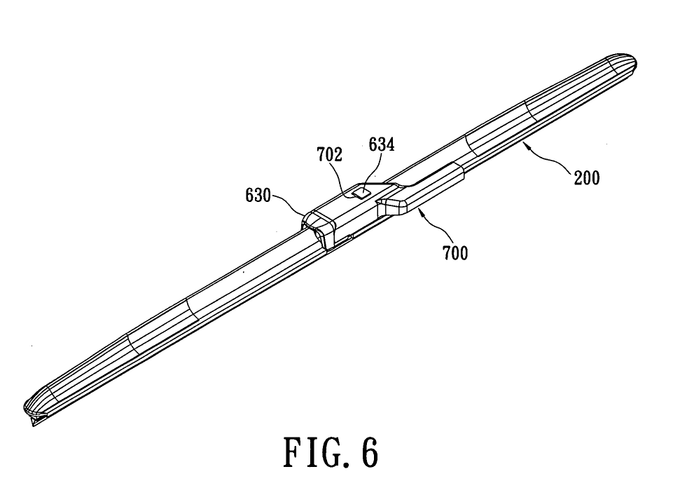

Please refer to FIGS. 5 and 6, which show the third embodiment of the present invention. The mask 630 includes a shaft 632 and a boss 634 formed from the top surface of the mask 630. The shaft 632 is disposed on the shaft base 120. The shaft 632 is fixed to the locking portions 124 of the shaft base 122 of the second connecting element 120. In the present embodiment, the top surface of the wiper arm 700 is provided with a hole 702. The hole 702 allows the boss 634 of the mask 630 to be locked therein. In this way, the wiper arm 700 can be connected to the windshield wiper blade 200 via the windshield wiper connector 100.

### Fourth Embodiment

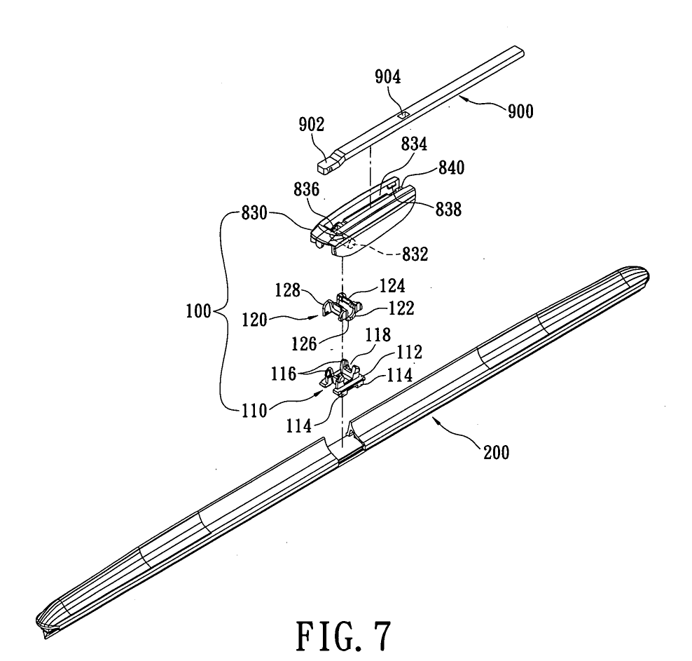

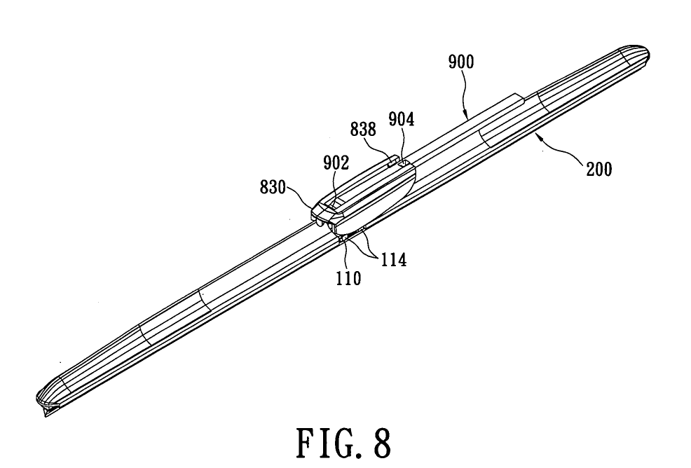

Please refer to FIGS. 7 and 8, which show the fourth embodiment of the present invention. The mask 830 includes a shaft 832, an elongate trough 834 provided on the bottom surface of the mask 830, a hole 836 provided on one side of the trough 834, two locking portions 838 provided on both side walls of the trough 834, and a boss 840 provided on the bottom of the trough 834. The shaft 832 is disposed on the shaft base 120. The shaft 832 is fixed to the locking portions 124 of the shaft base 122 of the second connecting element 120. In the present embodiment, the front end of the wiper arm 900 is formed with an L-shaped protruding plate 902. The rear end of the wiper arm 900 is provided with a hole 904 corresponding to the boss 840. The wiper arm 900 is disposed in the trough 834 of the mask 830. The protruding plate 902 is locked in the hole 836 of the trough 834 of the mask 830. The boss 840 of the trough 834 is inserted into the hole 904 of the wiper arm 900. The locking portions 838 of the trough 834 are fixed to the top surface of the wiper arm 900. In this way, the wiper arm 900 can be connected to the windshield wiper blade 200 via the windshield wiper connector 100.

### Fifth Embodiment

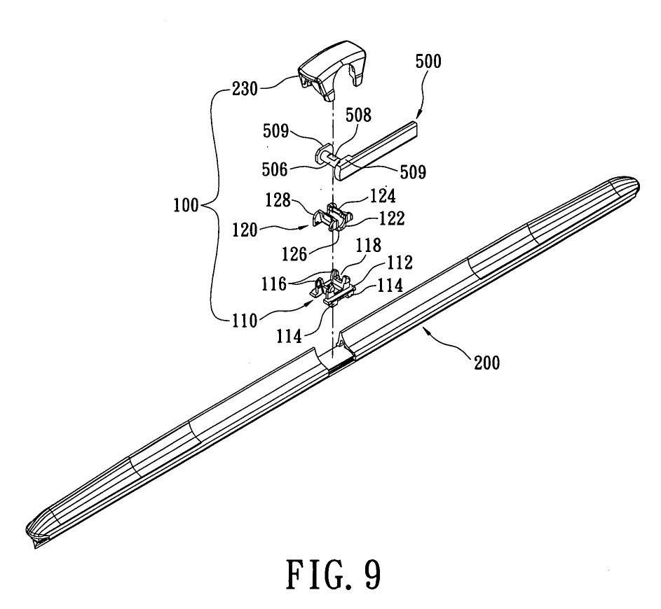

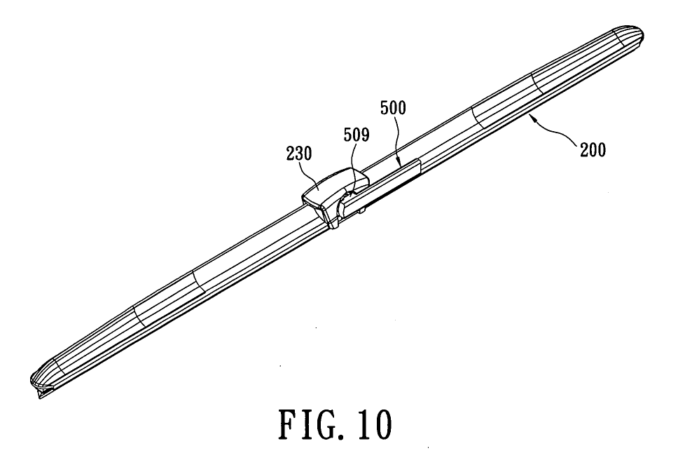

Please refer to FIGS. 9 and 10, which show the fifth embodiment of the present invention. The mask 230 further covers the outside of the wiper arm 500. In the present embodiment, the wiper arm 500 has a transverse pin 506, two troughs 508 provided in the wall surface of the transverse pin 506, and two retaining plates 509 formed on both ends of the transverse pin 506. The transverse pin 506 is disposed in the shaft base 122 of the second connecting element 120. The trough 508 is fixed to the locking portions 124 of the shaft base 122 of the second connecting element 120. The retaining plates 509 are stopped by outer walls on both sides of the shaft base 122. In this way, the wiper arm 500 can be connected to the windshield wiper blade 200 via the windshield wiper connector 100.

In comparison with prior art, the present invention has advantages as follows. The windshield wiper connector 100 of the present invention has a first connecting element 100 and a second connecting element 120 that can be used to the wiper arms 300, 500, 700, 900 of different kinds of cars. According to the wiper arms 300, 500, 700, 900, the user only needs to change the mask 130, 230, 630, 830. Furthermore, the first connecting element 110 and the second connecting element 120 are universal components and thus it is unnecessary to use different molds to manufacture these connecting elements. As a result, the manufacturing cost can be reduced.

While the present invention has been described in terms of what is presently considered to be the most practical and preferred embodiments, it is to be understood that the present invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A windshield wiper connector for connecting a windshield wiper blade to a wiper arm, comprising:
a first connecting element having a bottom plate, a plurality of first clips and two abutting portions, the first clips being bent and fixedly clipped to the windshield wiper blade;
a second connecting element having a semi-cylindrical shaft base, two locking portions, four wings and four hooks, the hooks being locked and connected to side walls of the abutting portions; and
a mask covering the outside of the first connecting element and the second element, the mask being connected to the wiper arm, wherein
the shaft base of the second connecting element is provided on the bottom plate of the first connecting element, the locking portions of the second connecting element are connected to the Abutting portions of the first connecting element, the shaft base of the second connecting element and the wings of the second connecting elements abut the abutting portions of the first connecting element.

2. The windshield wiper connector according to claim 1, wherein the first clips are plates extending from both sides of the bottom plate of the first connecting element.

3. The windshield wiper connector according to claim 1, wherein the abutting portions are U-shaped plates formed on the top surface of the bottom plate of the first connecting element.

4. The windshield wiper connector according to claim 3, wherein each of the side walls of the abutting portions is provided with a through hole, the locking portions of the shaft base are inserted into the through holes of the abutting portions.

5. The windshield wiper connector according to claim 1, wherein the locking portions are rectangular troughs formed on both sides of the inner wall of the shaft base.

6. The windshield wiper connector according to claim 1, wherein the hooks are protrusions of the wall surfaces of the wings.

7. The windshield wiper connector according to claim 1, wherein the wings are plates extending from both ends of the shaft base.

8. The windshield wiper connector according to claim 1, wherein the mask further comprises:
a shaft disposed on the shaft base of the second connecting element, the shaft being fixed to the locking portions of the shaft base of the second connecting element;
a protrusion formed on the front end of the mask;
a trough provided on the rear edge of the protrusion; and
two clipping arms formed by two sides of the rear end of the mask extending backwards,
wherein the wiper arm has a head, both sides of the head extend downwards to form a flange respectively, the lower edge of the flange is provided with a locking piece, the front end of the head is provided with a boss, the wiper arm is provided on the mask, the front end of the head abuts the protrusion, the boss on the front end of the head is locked in the trough of the mask, the two locking pieces of the wiper arm are locked with the two clipping arms of the mask.

9. The windshield wiper connector according to claim 1, wherein the mask further comprises:
a traversing portion formed on the top surface of the mask;
an insertion hole formed inwards and vertically in the side surface of the mask;
wherein the front end of the wiper arm has a traversing piece and a pin, the wiper arm is provided on the mask, the traversing piece traverses the traversing portion of the mask, the pin is inserted into the insertion hole of the mask and the shaft base of the second connecting element, and the pin is fixed to the locking portion.

10. The windshield wiper connector according to claim 1, wherein the mask comprises:
a shaft disposed on the shaft base of the second connecting element, the shaft being fixed to the locking portions of the shaft base of the second connecting element; and
a boss formed on the top surface of the mask;
wherein the top surface of the wiper arm is provided with a hole, the wiper arm is provided on the mask, and the hole allows the boss of the mask to be locked therein.

11. The windshield wiper connector according to claim 1, wherein the mask comprises:
a shaft disposed on the shaft base of the second connecting element, the shaft being fixed in the locking portions of the shaft base of the second connecting element;
an elongated trough provided on the bottom surface of the mask, one side of the trough being provided with a hole;
two locking portions provided on both side walls of the trough; and
a boss provided on the bottom of the trough;
wherein the front end of the bottom surface of the mask is formed into an L-shaped protruding plate, the rear end of the wiper arm is provided with a hole corresponding to the boss of the trough, the wiper arm is provided on the trough of the mask, the protruding plate is inserted in the trough of the mask, the boss of the trough is inserted in the hole, the locking portion of the trough is locked in the mask.

12. The windshield wiper connector according to claim 1, wherein the mask further covers the outside of the wiper arm, the wiper arm has a transverse pin, two troughs provided on the wall surface of the transverse pin, and two retaining plates formed on both ends of the transverse pin, the transverse pin is provided in the shaft base of the second connecting element, the troughs are fixed to the locking portions of the shaft base of the second connecting element, and the retaining plates are stopped by the outer walls on both sides of the shaft base.
